(19) United States
(12) Patent Application Publication
(10) Pub. No.: US 2010/0055656 A1
(43) Pub. Date: Mar. 4, 2010

(54) SYSTEM AND METHOD FOR PROVIDING VERBAL AND GRAPHICAL INSTRUCTION FROM A REMOTE HEALTHCARE MONITORING SERVICE HELPDESK

(75) Inventor: Johannes Hendrikus Maria Lemmers, Reek (NL)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/529,556

(22) PCT Filed: Feb. 14, 2008
(86) PCT No.: PCT/IB2008/050546

§ 371 Date: Sep. 2, 2009

Related U.S. Application Data
(60) Provisional application No. 60/893,743, filed on Mar. 8, 2007.

(51) Int. Cl. G09B 19/00

(52) U.S. Cl. 434/262; 434/365

(57) ABSTRACT

When installing a remote healthcare network system (10) in a users residence, a user input device, such as a remote control (26) for a home-end device (HED) (12) includes a helpdesk button (56) that the user (16) may depress to request a helpdesk session with a service provider helpdesk employee (20). The session is carried out using a network connection upon which a VoIP connection is built between the parties to permit verbal communication. Additionally, graphical information is exchanged using a broadband connection or the like. The HED (12) stores screenshots that represent actions the user (16) has performed during setup, and provides the screenshots to the helpdesk employee (20) during the session to assist the employee (20) in diagnosing the users problem. The employee (20) additionally sends graphical instructions or screen shots that are presented to the user (16) to instruct the user regarding a next action to resolve the issue. Additionally, when a reboot of the HED (12) is necessary to resolve the issue, the helpdesk session is automatically resumed upon reboot.

The present application finds particular application in healthcare and wellness systems, particularly involving assisting the elderly or infirm in configuring a remote health monitoring system. However, it will be appreciated that the described technique may also find application in other remote access systems, other system setup and/or system configuration scenarios, etc.

Complex networking devices that are to be installed at a consumer's home often require complicated configuration, which may differ between users, service providers, countries, etc. This in turn further exacerbates difficulties that may be experienced by users. Other problems arise when a user has little experience and/or aptitude for configuring a network, let alone setting network security parameters during configuration of the network. Moreover, users of advanced age often have other limitations that can hamper system installation, such as degraded eyesight and/or lack of experience with newer technologies. For example, it can be difficult for a user with poor eyesight or compromised cognitive abilities to correctly enter an encrypted security key with multiple alphanumeric characters, varied upper- and lower-case characters, etc. Often, repeated mistakes in security key entry can result in user frustration and disregarding of the protocol, which in turn leaves the network connection insecure and vulnerable. Additionally, usage of technical systems with remote controls, complex menu structures, and various applications like video-streaming, e-mail, questionnaires and graphs is challenging for users, especially elderly people. Alternatively, such a user may be forced to pay a premium for a professional to make a house call to install the system or occupy a service provider help line for an extended duration in an attempt to identify the problem, both of which add to overall system cost. The present application provides new and improved user identification and network configuration systems and methods, which overcome the above-referenced problems and others.

Traditional helplines permit a user to speak with to a customer service employee telephonically. However, it is often difficult for users to clearly describe the problem, and even more challenging for a helpline employee to explain a solution to a user. For instance, an elderly person with little technical experience may not be able to locate the power cable on a device when several cables extend from the device. Moreover, users often do not recall actions they have taken and/or settings they have changed to configure a device.

In accordance with one aspect, a system for providing verbal and graphical instruction from a remote healthcare monitoring service helpdesk, includes a home-end device (HED) with a VoIP component that provides a VoIP communication link with a centralized server, and a memory that stores screenshots historical information associated with user actions during installation or operation of the HED. The system further includes a GUI that presents graphical images to the user, and a speaker through which audio information is output to the user.

In accordance with another aspect, a method of troubleshooting installation and normal operation of a remote healthcare system includes storing screenshots that describe HED installation actions that a user has completed, optionally stripping privacy-sensitive information from the screenshot information and storing the screenshots at a server, and receiving a request for a user helpdesk session. The method further includes initiating the helpdesk session and providing a connection between the HED and the server, which enables bi-directional communication between the user and a helpdesk employee, and providing real-time video of a helpdesk employee to the HED for display to the user on the a GUI coupled to the HED. The method still further includes receiving, at the server, the stored screenshots for review by the helpdesk employee, and providing graphical instructions to the HED and displaying them on the GUI.

One advantage is that users are provided with both graphical and verbal instructions to reduce issue resolution time.

An additional advantage is the support of technical features to provide easy and direct access to the helpdesk service.

Another advantage resides in storing user actions in persistent memory to permit a helpdesk employee to review user actions for problem analysis.

Another advantage resides in providing automatic helpdesk session resumption after a system reboot.

Still further advantages of the subject innovation will be appreciated by those of ordinary skill in the art upon reading and understand the following detailed description.

The innovation may take form in various components and arrangements of components, and in various steps and arrangements of steps. The drawings are only for purposes of illustrating various aspects and are not to be construed as limiting the invention.

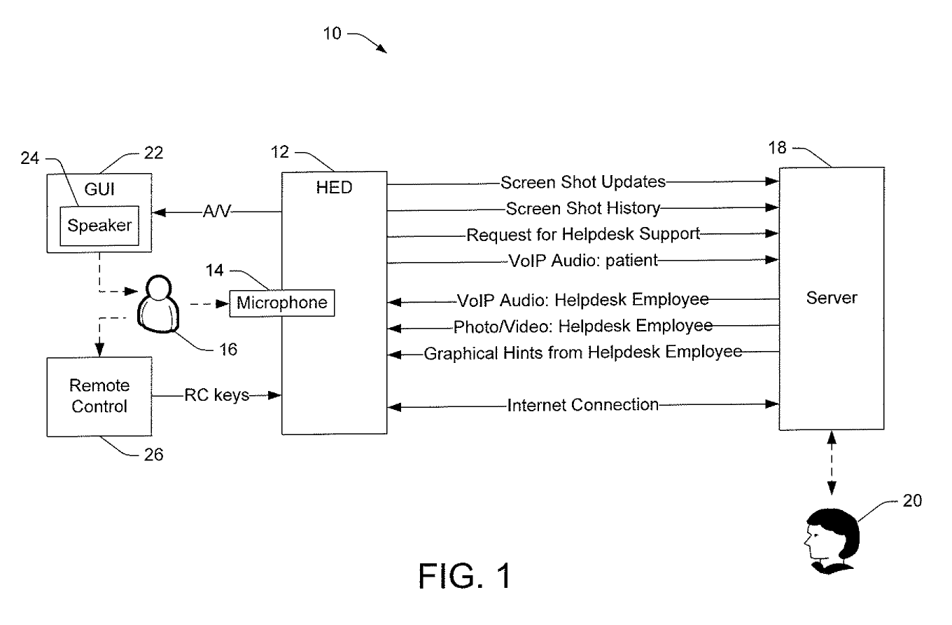

FIG. 1 illustrates a system that provides real-time customer support for installation and/or operation of a home-end device (HED), such as for a remote healthcare monitoring system.

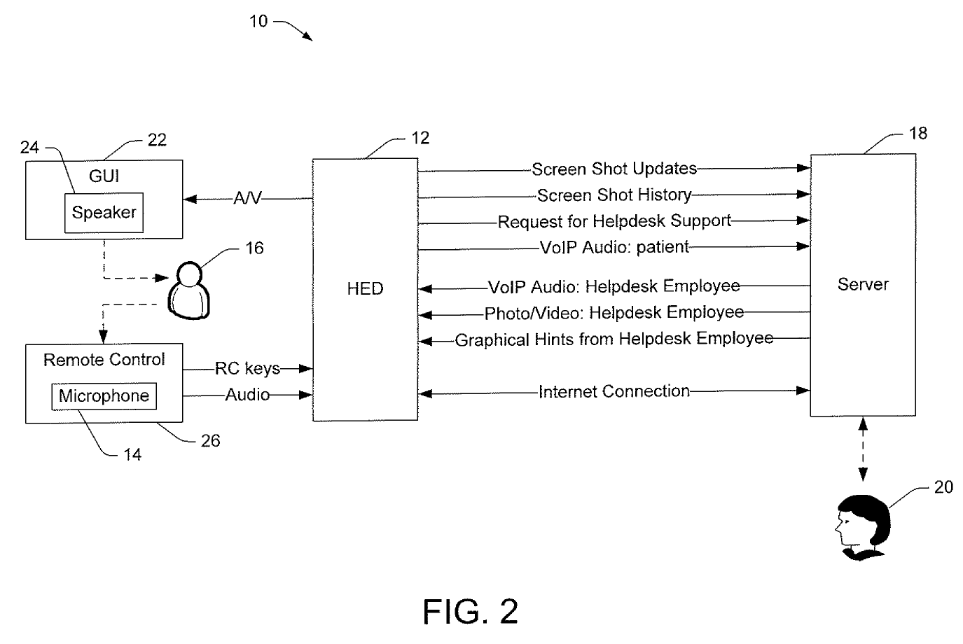

FIG. 2 illustrates the system for providing a complete helpdesk solution for a remote patient using a home monitoring system that enables a service provider to provide highly improved support to patients.

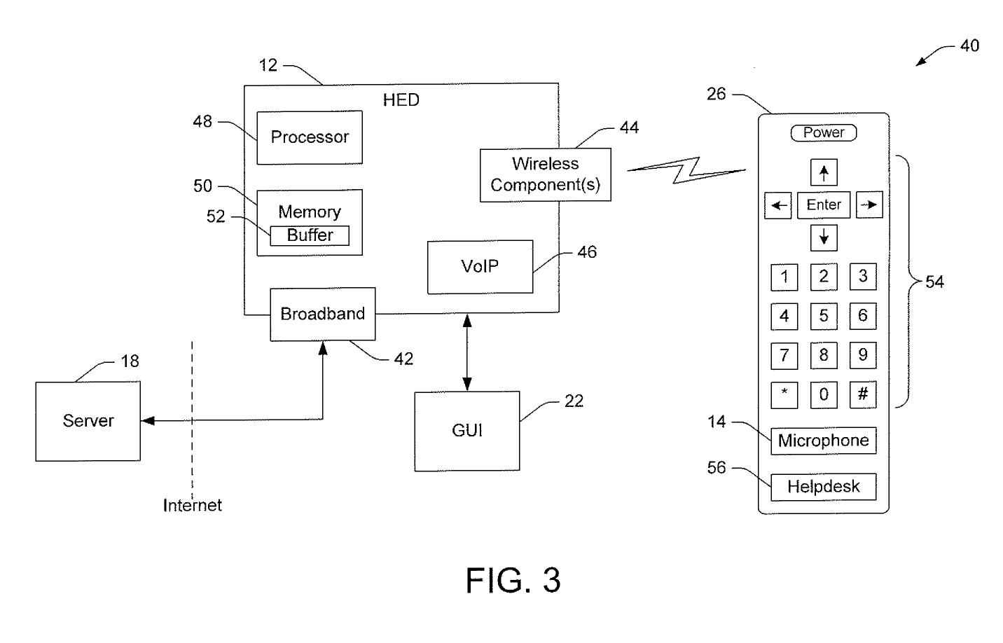

FIG. 3 shows a system for reducing a threshold of technological understanding required by a user of a remote patient monitoring system, in order to permit technologically unsavvy users, such as the elderly, install and use the remote monitoring system.

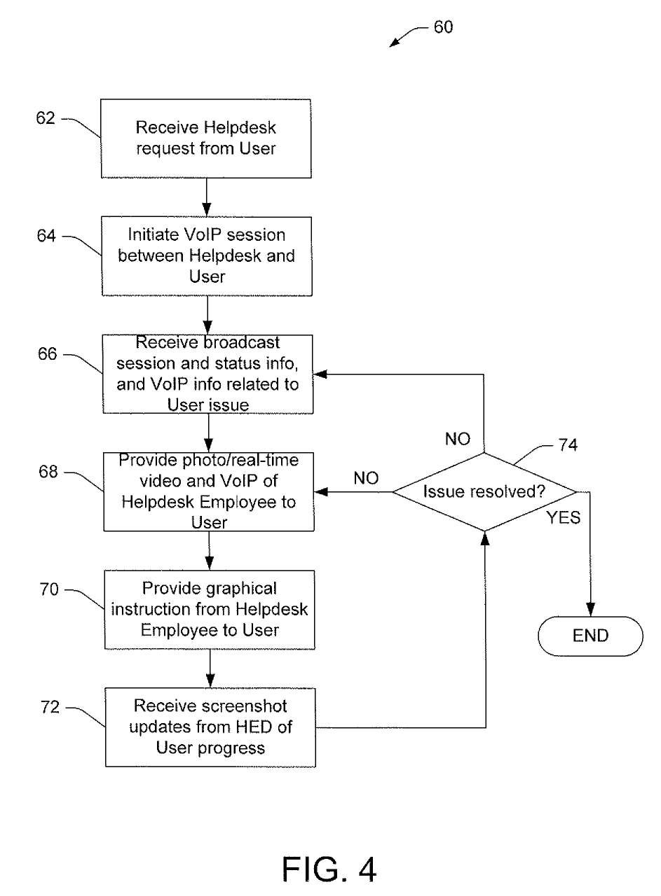

FIG. 4 illustrates a method for providing a helpdesk session to a patient in a remote location using a VoIP protocol to permit verbal communication between a helpdesk employee and the patient, and by providing, via a separate broadband channel, screenshots descriptive of patient actions to the helpdesk employee to facilitate understanding of the patient's problem or issue.

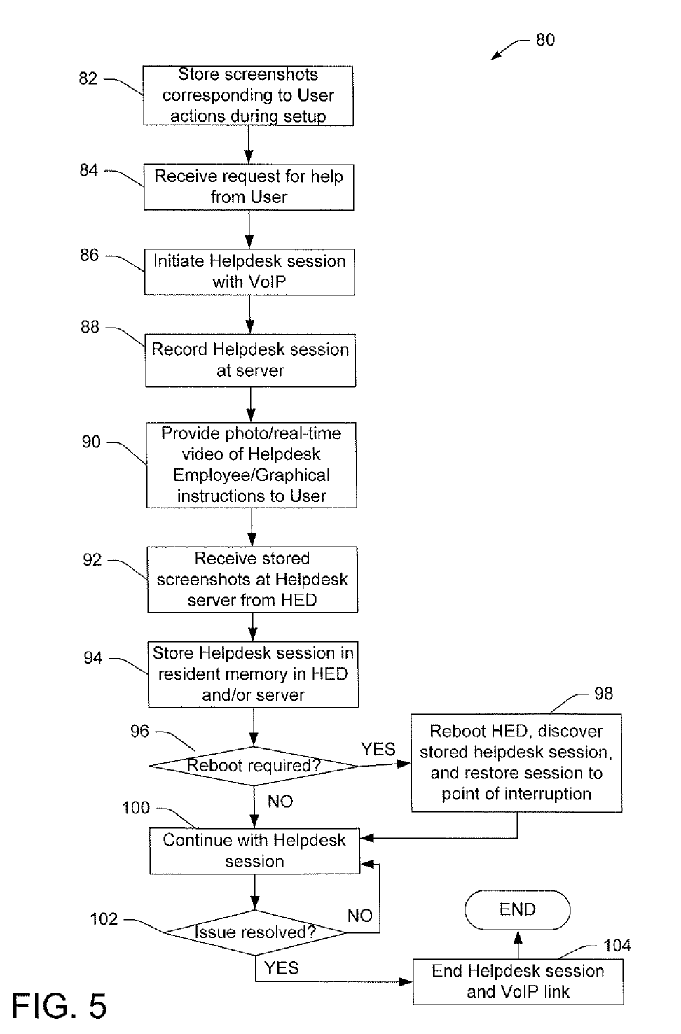

FIG. 5 illustrates a method of initiating, maintaining, and automatically resuming a helpdesk session between a helpdesk employee at a centralized service provider location and a remote patient, or user, using a VoIP protocol and stored screenshots related to user activity.

FIG. 1 illustrates a system 10 for providing real-time customer support for installation and/or operation of a home-end device (HED) 12, in accordance with various features described herein. In some embodiments, the HED 12 is a set-top box or the like, and includes a microphone 14 into which a user 16 speaks (e.g., using a voice-over Internet protocol, or VoIP, etc.) to communicate a problem or issue over an Internet connection to a service provider server 18. The microphone can be integral to the HED, or can be connected by a cable or wireless link to the HED. The service provider may be, for example, a healthcare service provider that maintains a centralized server 18 that communicates with a plurality of remote HEDs 12 in various patients' residences or the like. The user can call a helpdesk employee 20 by initiating a call, for example by pressing the ‘helpdesk’ button on the remote control, causing the HED to connect (e.g., over the Internet) to the server and the helpdesk employee. Information can be sent by the helpdesk employee from the server to the HED for output to the user via a GUI 22 (e.g., a television connected to the HED 12, a laptop screen, a touchscreen, or some other suitable GUI). The GUI includes a speaker 24 that permits the user to hear information provided by the helpdesk employee while viewing corresponding graphical information on the GUI. The user can enter information to the HED using a remote control 26, which provides an infrared (IR) communication link with the HED, over which remote control keys are transmitted to the HED. It will be appreciated that the speaker can also be an extension of the HED (e.g. integral or external to the HED, etc.).

According to an example, the user 16 transmits a helpdesk support request from the HED to the server over the Internet connection. The helpdesk employee responds to the user's request via a VoIP connection that permits the user and the helpdesk employee to communicate as if speaking telephonically. That is, the user can hear the helpdesk employee through the speaker in the GUI, and can talk to the helpdesk employee using the microphone in the HED. Thus, VoIP audio can be transmitted bi-directionally between the parties. Additionally, the server can transmit photo and/or real-time video of the helpdesk employee to the HED for presentation on the GUI to the user, which provides a more robust interface for the user during the helpdesk session. The HED stores and transmits screenshots (e.g., a bitmap dump of a screen or a description of elements visible at the screen, similar to a vector image, etc.) associated with user actions to the server for viewing by the helpdesk employee. Additionally, user privacy-sensitive information (e.g., name, ID number(s), etc.) may be masked or removed from the pictures stored at the HED, stored at the server, or stored in both places, prior to being presented to the helpdesk. Moreover, screenshots associated with completed user actions can be stored at the server to ensure that privacy-sensitive information is not accessible to non-privileged persons.

For instance, the user can attempt to use the HED, and upon encountering a problem, the user initiates the helpdesk session. The helpdesk employee can receive historical information, such as a series of screenshots representing actions the user has already performed. For instance, if the user has plugged the HED into a power outlet and inserted an instructional DVD or the like, then actions performed in response to the instructional DVD can be recorded in persistent memory in the HED and an indication of such can be provided to the helpdesk employee at the inception of the helpdesk session. In this manner, the helpdesk employee can be apprised of the user's progress in order to better understand the issue or problem that prompted the user to initiate a helpdesk session.

To further this example, the helpdesk employee transmits graphical hints or instructions to the user via the server and HED, and the instructions are presented the user on the GUI. For instance, if the helpdesk employee recognizes that the user needs to reboot the HED (e.g., by disconnecting and reconnecting the power cable), the helpdesk employee can transmit an image of the power cable and its point of attachment to the HED. This graphical instruction can save substantial amounts of time that may otherwise be required to explain verbally, to a technologically unsavvy user, how to disconnect the power cable from the HED.

Additionally, the HED 12 transmits updated screenshots to the server 18 for the helpdesk employee 20 to review. Screenshot update information relates to actions that the user has performed recently, which may not have been included in the screen shot history provided to the helpdesk employee at the inception of the helpdesk session. In this manner, the helpdesk employee receives updates indicative of user actions taken, and is able to provide more refined instruction to resolve the user's issue. Alternatively, the screenshots are stored at the server side.

FIG. 2 illustrates the system 10 for providing a complete helpdesk solution for a remote patient using a home monitoring system that enables a service provider to provide highly improved support to patients. The system includes a plurality of components, such as are described above with regard to FIG. 1. For instance, an HED 12 communicates, via the Internet, with a centralized server 18. In this manner, a user 14 can interact with a helpdesk employee 20 using bi-directional VoIP communication. Additionally, screenshot history and/or updates are provided by the HED to the server for helpdesk employee review, and the helpdesk employee can provide graphical and verbal instruction to the HED, which can be presented to the user via a GUI 22 that includes a speaker 24. According to some embodiments, the speaker is external to the GUI and connected by a cable or wireless link. According to other embodiments, the speaker is an extension of the HED itself.

According to another feature, a microphone 14 is included in remote control 26, which allows the user to enter information to the HED for transmission to the server and eventually the helpdesk employee. For instance, the user can enter information using buttons on the remote control, which can be manipulated to select icons on the GUI, to enter digits and the like, etc. The remote can transmit information entered using the buttons over an IR channel between the remote and the HED. Additionally, the user can speak into the microphone with or without knowing that the microphone is present. For instance, the user may think he or she is talking to the GUI, but the microphone in the remote control picks up the sound of the user's voice, and such voice information is transmitted using Bluetooth, Zigbee, or the like, to the HED. In addition to the microphone, the remote control can include a button that, when depressed, triggers the HED to initiate a helpdesk session.

The HED 12 provides VoIP functionality to permit a voice connection with the service provider. The user speaks into the microphone 14 and the speaker is used as loudspeaker for the helpdesk employee's voice. The HED stores the history of screens shots passed through by the patient. These screen shots provided to the helpdesk employee at the moment a request for support is made. The HED can switch to helpdesk-mode upon initiation of a helpdesk session by the user. In this mode, any change to the screen (e.g., as the user navigates through one or more screens) is also sent to the helpdesk employee. The helpdesk mode and helpdesk session data is stored in resident memory in the HED, so that if the session is interrupted (e.g., due to power failure, user action etc.), the support session (with the same employee) can be continued when the HED reboots. A visual presentation (e.g., a photo or streaming video) of the helpdesk employee becomes visible on the GUI to make the support more personal. The helpdesk employee can send photos to the GUI screen to support his/her instructions with graphics. For example, when the user has to remove and reinsert the power cable, a photo of the power cable can be shown. Additionally, the server records all helpdesk calls for each patient, or user. Analysis of this information provides the service provider with a specific user profile for each patient. Based on this information, the service provider may decide to give the patient additional courses of special care, additional instruction courses, withdraw the system from the user's residence, adjust the user's care regimen, etc.

FIG. 3 shows a system 40 for reducing a threshold of technological understanding required by a user of a remote patient monitoring system, in order to permit technologically unsavvy users, such as the elderly, install and use the remote monitoring system. The system includes an HED 12 that includes a broadband component 42, such as a modem or the like, which connects the HED to a server 18 maintained by a healthcare service provider. The broadband component can connect to the server using, for instance, an Ethernet protocol or the like. Additionally, the HED includes one or multiple wireless components 44 that receive information from a remote control device 26. For example, the user inputs information manually into the remote control, using a plurality of buttons 54 that includes without being limited to a number of directional buttons (e.g., up, down, left, right, etc.) for selecting an image or word on a GUI 22 and/or for navigating through screens presented to the user on the GUI, as well as a number of buttons for inputting digits and the like. User input is received by the wireless component 44 via IR, radio frequency, Bluetooth, Zigbee, or similar communication protocol. Additionally, the remote control 26 includes a microphone 14 into which the user speaks, and audio information associated with the user's voice is received by the wireless component using Bluetooth, Zigbee, or a similar protocol.

The system further includes a helpdesk button 56 that the user depresses to initiate a helpdesk session. Upon initiation of the session, the HED 12 goes into helpdesk mode and initiates a VoIP session with the server 18 using a VoIP component 46. The user can then communicate using the VoIP connection as though on the telephone with a helpdesk employee at the server 18 (e.g., a bi-directional audio link is thus provided). The server includes any and all hardware and/or software to maintain the VoIP connection, as well as to provide the user with an image or video of the helpdesk employee and/or graphical instructions to resolve the user's issue, as will be appreciated by those of skill. The HED additionally includes a processor 48 that executes instructions related to performing the various actions and/or protocols described herein, and a memory 50 that stores information related to one or more routines, protocols, etc., for providing a broadband connection with the server, for creating and maintaining the VoIP communication link, communicating wirelessly with the remote control 26, etc. Additionally, the memory includes a buffer 52 that stores screenshots related to user actions during system installation (or at other times during other actions). When the user initiates a helpdesk session, a screenshot history is transmitted to the server for review by a helpdesk employee to bring the helpdesk employee up to speed with regard to the issue or problem that prompted the user to initiate the helpdesk session. Additionally, the buffer stores updates to the screenshot history, which show actions taken by the user during the helpdesk session in response to instructions provided by the helpdesk employee. In this manner, the helpdesk employee can see what the user is seeing to better guide the user through the installation and/or operation process, while providing real-time verbal instruction over the VoIP connection. It will be appreciated that buffer 52 may be a ring buffer (e.g., a circular buffer) or other suitable buffer for performing the described actions, and stores a number of previously viewed screens, N, where N is an integer.

It will be appreciated that the memory 50 is a persistent memory that additionally stores the helpdesk session so that the system can resume the helpdesk session in the event that a system reboot becomes necessary to resolve the user's issue. Additionally or alternatively, the session information can be stored at the server, to be retrieved with a unique device recognition identification. In this manner, the user can be instructed to reboot the system at an appropriate time (e.g., by removing and reapplying power or the like), and upon reboot the user and helpdesk employee session is restored (e.g., with VoIP and visual communication) so that the user can receive further instruction, the helpdesk employee can verify issue resolution, etc. According to other embodiments, the server 18 records helpdesk issues for each user or patient, and the helpdesk issue history can be used to make healthcare service decisions for the patient. For instance, if the patient is so infirm or technologically unsavvy that he or she initiates a helpdesk session with high frequency relative to other users (e.g., more than a predetermined number of sessions within a predefined time period, etc.), then a determination may be made that the user is not benefiting from the remote healthcare system and appropriate action may be taken, such as providing in-person healthcare or the like. According to other examples, if a user initiates a helpdesk session repeatedly for the same or similar issues, a determination may be made to send the user pre-recorded instruction in response to initiation of a current helpdesk session based on a prediction that the current issue will be similar to the most common issue in the stored history. In this manner, helpdesk employee resources are conserved.

According to another example, a patient may be working with a remote healthcare service, viewing screens on the GUI 22 associated with the HED 12, when the patient experiences a problem. The patient then depresses the helpdesk button 56 on the remote 26, causing the HED to switch to helpdesk mode and establish a connection with an available helpdesk employee at the service provider. A photo of the helpdesk employee appears on the GUI, and the patient is able hear the helpdesk employee's voice through a speaker associated with the GUI. The speaker may be integral or external to the GUI, and/or may be integral or external to the HED. According to a related embodiment, real-time video of the helpdesk employee can be transmitted from the server 18 to the HED 12 for display to the patient via the GUI. The HED passes recent screen shots (e.g., passed through or viewed by the patient before running into problems) to the helpdesk employee. The helpdesk employee can ask the patient, via the VoIP connection, what the problem is, the patient can respond, and the microphone 14 picks up the patient's voice (e.g., without having to move the remote control to the patient's mouth). The helpdesk employee listens to the question of the patient and determines a solution as a function of the history of screen shots and system data provided to the server by the HED. The helpdesk employee then explains the solution to the patient and sends graphical instructions to the HED for display on the GUI. The patient attempts to execute the solution, and patient actions are monitored by the helpdesk employee because the HED sends all interaction to the helpdesk. When the problem is resolved, the helpdesk employee sends a command that instructs the HED to exit helpdesk mode, and the session is finished. During the helpdesk session, screenshot data describing actions executed by the patient is stored in persistent memory to facilitate rebooting the HED, if necessary to resolve the problem. In this manner, once the patient has executed the instructions provided by the helpdesk employee (e.g., verbally and/or graphically) the patient can reboot the HED to effect the changes, and then automatically be reconnected to the helpdesk employee, who then verifies that the solution resolved the patient's problem and ends the helpdesk session. According to other embodiments, the helpdesk takes over the HED and shows a usage scenario to the user, including a visual display of the virtual key pressed by the “helpdesk” to execute the scenario.

FIGS. 4-5 illustrate one or more methods related to providing a helpdesk session using VoIP to assist a patient in installing and/or configuring a remote health monitoring system, in accordance with various features. While the methods are described as a series of acts, it will be understood that not all acts may be required to achieve the described goals and/or outcomes, and that some acts may, in accordance with certain aspects, be performed in an order different than the specific orders described.

FIG. 4 illustrates a method 60 for providing a helpdesk session to a patient in a remote location using a VoIP protocol to permit verbal communication between a helpdesk employee and the patient, and by providing, via a separate broadband channel, screenshots descriptive of patient actions to the helpdesk employee to facilitate understanding of the patient's problem or issue. At 62, a helpdesk employee and/or server at the service provider receives a helpdesk session request from the patient, or user, which the user initiates by depressing a helpdesk button on a remote control associated with the user's HED. Depressing the helpdesk button causes a signal to be transmitted from the remote control to the HED (e.g., using Bluetooth, Zigbee, IR communication, RF communication, or some other wireless communication protocol) to place the HED in helpdesk mode. Optionally, the helpdesk button can be located on the HED itself. In this mode, the HED initiates a VoIP communication link with the centralized server at the healthcare provider's office, at 64. A helpdesk employee at the service provider's office then greets the patient verbally, and is able to receive information from the patient regarding the patient's problem over the VoIP connection, at 66, in addition to receiving session and status information of the HED over a broadband connection. The patient's problem may be related to installation or operation of the HED, components associated with the HED (e.g., patient monitoring devices, a GUI, etc.), or some other problem that the patient has encountered. In some embodiments, the patient may initiate the VoIP connection to communicate an emergency condition to the helpdesk employee, such as to request an ambulance or immediate medical attention.

In addition to the VoIP connection, at 68, the server can provide a photo or real-time video of the helpdesk employee to the HED over an Internet connection or the like, for presentation to the user on a GUI, which personalizes the helpdesk session. The helpdesk employee additionally provides graphical instructions to the user via the Internet connection, at 70, and is able to explain the instructions verbally over the VoIP connection, if necessary. The HED forwards information, via the broadband connection, to the server for viewing by the helpdesk employee in the form of screenshots that the user has viewed or navigated through during operation, at 72. The HED can maintain a catalogue or history of screenshots visited by the user prior to calling the helpdesk to provide the helpdesk employee with information that facilitates discerning the user's problem, as well as screenshots visited during the helpdesk session so that the helpdesk employee can monitor the user's progress in resolving the problem that prompted the helpdesk session. At 74, a determination is made regarding whether the user's issue has been resolved.

If the issue is not resolved, then the method can revert to either 66, where the helpdesk employee receives further information from the user regarding the problem (e.g., verbal information over the VoIP connection and/or status and session information over the broadband connection), or to 68, where the helpdesk employee provides further information to the user to continue working to a solution to the user's issue. If the determination at 74 indicates that the user's issue has been resolved, the helpdesk employee can ask the user whether there are any other issues requiring attention, politely terminate the helpdesk session, or both. In this manner, a centralized helpdesk employee can send and receive both graphical and verbal information to and from a patient that is technologically unsavvy and might otherwise occupy an inordinate amount of helpdesk time over telephone or the like. In another embodiment, the user can initiate a helpdesk request by leaving a voice mail or text massage and transmitting the screenshots. The helpdesk employee can telephone, email, and/or send a send a series of instructional video screens to the user when a solution has been determined.

FIG. 5 illustrates a method 80 of initiating, maintaining, and automatically resuming a helpdesk session between a helpdesk employee at a centralized service provider location and a remote patient, or user, using a VoIP protocol and stored screenshots related to user activity. At 82, screenshots relating to user actions are stored in persistent memory in an HED that has been provided to the user by the service provider. Screenshots are graphical representations of “screens” that the user has viewed or otherwise navigated through, presented to the user on a GUI connected to the HED. For instance, the user can be presented with a series of screenshots to facilitate using the HED. According to this example, the user connects the HED to a GUI such as a television, a laptop, or some other device, and connects both devices to a power source such as a wall outlet. The user then turns on both devices, and is presented with a series of screenshots that guide the user through an activity (e.g., viewing healthcare-related educational video, answering survey questions, etc.). Once each action is complete, the user advances to a subsequent screenshot. For instance, the user can complete an action and verify its completion by depressing an indicated or designated button on a remote control associated with the HED. As each screenshot is completed, it is stored in the HED in persistent memory.

At 84, a server at the service provider receives a request for help from the user, such as may be transmitted by the user upon depression of a helpdesk button on the remote control or the like. Upon depression of the button, the remote control sends a wireless (e.g., Bluetooth, IR, Zigbee, RF, etc.) signal to the HED, which in turn sends a helpdesk session request to the server via an Internet/Ethernet connection to initiate the helpdesk session with VoIP, at 86. At 88, the server begins recording the helpdesk session to maintain a record thereof, including screenshot histories, graphical instructions, etc. At 90, the helpdesk employee and/or the server provide a photo and/or real-time video of the helpdesk employee to the user to personalize the helpdesk session. Additionally, the helpdesk employee provides graphical instruction and/or verbal instruction to the user to attempt to resolve the user's issue. At 92, the helpdesk employee receives the stored history of screenshots from the HED, and the helpdesk employee assesses the user's progress based thereon. At 94, the helpdesk session is stored in persistent memory in the HED to facilitate automatically resuming the helpdesk session if necessary. For instance, screenshots that the user completes or navigates through during the helpdesk session are stored in the HED and/or at the server. Storage of the screenshots may be separate from or part of the screenshot history that is maintained in the HED and/or the server.

At 96, a determination is made regarding whether the HED requires a reboot, such as by cessation of power to the HED. For example, at some point during the helpdesk session, it may become necessary to reboot the HED to effectuate changes implemented by the user during the helpdesk session. In such a case, the helpdesk employee instructs the user to turn the HED off and then back on, or to disconnect the power cable from the HED or the wall socket to remove power, and then to reconnect the power cable. Such instructions can be given to the user verbally over the VoIP connection and/or graphically, for instance as a screenshot that depicts the power cable, its location, its connection to the HED, etc., to permit the user to easily identify the power cable, unplug it, and plug it back in at a designated time. In this manner, the user interrupts power to the HED to cause a reboot. Thus, if the determination at 96 indicates that the HED should be rebooted, then at 98, the HED reboots upon restoration of power, discovers the stored helpdesk session at 94, and the helpdesk session is restored to a current state immediately prior to cessation of power. Storage of the helpdesk session information can occur at the HED, at the server, or both, and information stored at 94 is utilized at 98 to resume the helpdesk session, which then continues at 100.

If the determination at 96 indicates that no reboot is necessary, then at 100, the helpdesk session continues as normal. At 102, a determination is made regarding whether the user's issue has been resolved. If the issue has not been resolved, then the method reverts to 100, where the helpdesk session continues as normal. If the issue has been resolved, then at 104, the helpdesk session and the VoIP link between the server and the HED are ended. In this manner, a helpdesk session is initiated, maintained, and automatically resumed after an HED reboot, to permit a remote user and a centralized helpdesk employee to communicate both verbally (e.g., using the VoIP connection) and visually (e.g., using an Internet or Ethernet connection to provide screenshots, graphical instructions, etc.).

Having thus described the preferred embodiments, the invention is now claimed to be:

1. A system (10, 40) for providing verbal and graphical instruction from a remote healthcare monitoring service helpdesk, including:
a home-end device (HED) (12) with a communication link with a centralized server (18), and a memory that stores historical information associated with user actions during installation or operation of the HED (12);
a GUI (22) that presents graphical images to the user (16); and
a speaker (24) through which audio information is output to the user.

2. The system according to claim 1, wherein the HED (12) further includes a wireless component (44) that receives wireless signals from a remote control (26).

3. The system according to claim 2, wherein the system (10, 40) further includes a helpdesk button (56) that the user actuates to initiate a helpdesk session with a helpdesk employee (20) at the centralized server (18).

4. The system according to claim 3, wherein the HED (12) receives a wireless helpdesk session signal from the remote control (26), enters helpdesk mode, and sends a helpdesk session request to the centralized server (18).

5. The system according to claim 1, wherein the HED (12) transmits the stored historical information to the server (18) for review by the helpdesk employee (20).

6. The system according to claim 5, wherein the historical information includes at least one of screenshots, a history of buttons pressed by the user, received measurement data, or systems status.

7. The system according to claim 6, wherein the screenshot is at least one of a bitmap image or a description of screen elements.

8. The system according to claim 6, wherein user privacy-sensitive information is removed from the screenshot.

9. The system according to claim 6, wherein the screenshots are stored at the server (18) and protected against viewing by unauthorized personnel.

10. The system according to claim 5, wherein the helpdesk employee (20) sends graphical instructions from the server (18) to the HED (12) for presentation to the user (16) on the GUI (22).

11. The system according to claim 5, wherein the helpdesk employee (20) provides verbal instructions to the user (16) via the VoIP connection, and wherein the verbal instructions are presented to the user (16) through the speaker (24) coupled to the GUI (22).

12. The system according to claim 1, wherein the HED (12) automatically resumes an interrupted helpdesk session with the server (18) upon reboot of the HED (12) using the stored historical information, and wherein the memory that stores historical information is located in at least one of the HED (12) or the server (18).

13. The system according to claim 1, wherein the HED (12) includes a VoIP component (46) that provides a VoIP communication link with the server (18), and a microphone (14) into which a user (16) speaks during VoIP communication.

14. The system according to claim 1, further including:
a routine or means (62) for receiving a helpdesk session request at the centralized server (18);
a routine or means (64) for initiating a VoIP session between the helpdesk and the user;
a routine or means (66) for receiving VoIP information related to the user's issue over a VoIP connection and system status information related to the user's issue over a broadband connection;
a routine or means (68) for transmitting VoIP or graphical information from the centralized server (18) to the HED (12);
a routine or means (70) for presenting graphical instruction to the user (16); and
a routine or means (72) for storing screenshots related to user actions and receiving the stored screenshots at the centralized server (18) for review by the helpdesk employee (20).

15. A method of communicating using the system (10, 40) of claim 1, including:
receiving a request for a helpdesk session from the user (16);
initiating a session between the helpdesk and the user (16);
receiving information from the user (16) describing the user's problem;
providing real-time video of a helpdesk employee (20) to the user (16);
providing graphical and verbal instruction to the user (16) via the GUI (22);
periodically evaluating whether the user's problem has been resolved;
continuing the helpdesk session if the user's problem has not been resolved or terminating the helpdesk session if the user's problem has been resolved; and
storing helpdesk session information and automatically restoring the helpdesk session using the stored information if the system is rebooted during the helpdesk session.

16. A method for resolving a user problem using the system (10, 40) of claim 1, including:
storing screenshots associated with user actions during setup or use of the HED (12);
receiving a request for help from the user (16);
initiating a helpdesk session between the HED (12) and the centralized server (18);
recording the helpdesk session at the centralized server (18) for retrieval via a unique device recognition identification in the event of a system reboot;
updating the server (18) with information related to actions taken at or on the HED (12) during the helpdesk session; providing real-time video of a helpdesk employee (20), and graphical instructions, to the user (16);
receiving the stored screenshots at the centralized server (18);
storing the helpdesk session in the HED (12);
and updating status changes at the HED (12);
employing the stored screenshots to determine feedback information in response to the help request; and
terminating the helpdesk session upon resolution of the issue that prompted the user request for the helpdesk session.

17. The method according to claim 16, further including resuming the helpdesk session if the HED (12) is rebooted.

18. The method according to claim 16, further including at least one of storing the screenshot information at the server (18) or stripping the screenshots of user privacy-sensitive information.

19. A method for troubleshooting installation and normal operation of a remote healthcare system (10, 40), including:
storing screenshots that describe HED (12) installation actions that a user (16) has completed;
optionally stripping privacy-sensitive information from the screenshot information and storing the screenshots at a server (18);
receiving a request for a user helpdesk session;
initiating the helpdesk session and providing a connection between the HED (12) and the server (18), which enables bi-directional communication between the user (16) and a helpdesk employee (20);
providing real-time video of a helpdesk employee to the HED (12) for display to the user (16) on the a GUI (22) coupled to the HED (12);
receiving the stored screenshots at the server (18) for review by the helpdesk employee (20); and
providing graphical instructions to the HED (14) and displaying them on the GUI (22).

20. The method according to claim 19, further including providing a VoIP connection and verbal instructions to the user (16) via the VoIP connection and a speaker (24) in the GUI (22), and receiving verbal information from the user (16) over the VoIP connection.

21. The method according to claim 19, further including recording information associated with the helpdesk session at the server (18) and at the HED (12).

22. The method according to claim 21, wherein recording information associated with the helpdesk session includes storing screenshots associated with user-completed actions.

23. The method according to claim 21, further including instructing the user (16) to reboot the HED (12) during the helpdesk session, and automatically resuming the helpdesk session after the HED (12) has rebooted.

24. The method according to claim 21, further including employing the helpdesk session information stored at the server (18) to make decisions related to healthcare service provided to the user (16).

25. A processor (48) or computer medium (50) programmed to perform the method of claim 19.

26. A system for communicating verbally and graphically with a remote patient, including:
means (52) for storing screenshots describing user activities performed during operation of an HED (12);
means (42) for receiving graphical and verbal instruction from a helpdesk employee (20), and for transmitting screenshots to a centralized server (18) for evaluation by the helpdesk employee (20); and
means (22, 24) for presenting received graphical or verbal instructions to the user for execution.

27. The system according to claim 26, further including means (26) for permitting the user (16) to enter information into an HED (12), the means (26) includes a means (14) for receiving audio input from the user and a means (56) for requesting a helpdesk session with a helpdesk employee (20).

28. The system according to claim 26, further comprising means (46) for communicating using a VoIP protocol.
